(19) United States
(12) Patent Application Publication
(10) Pub. No.: US 2006/0282385 A1
(43) Pub. Date: Dec. 14, 2006

(54) Methods and apparatus for a wireless terminal with third party advertising: authentication methods

(75) Inventors: Liang Cheng, Parsippany, NJ (US); Winston Hong Lieu, Holmdel, NJ (US); Haixong Zhao, Holmdel, NJ (US)

Correspondence Address: DEMONT & BREYER, LLC, 100 COMMONS WAY, HOLMDEL, NJ, 07733, US

(73) Assignee: Mobicom Corporation, Holmdel, NJ (US)

(21) Appl. No.: 11/145,606

(22) Filed: Jun. 6, 2005

(51) Int. Cl. G06Q 99/00

(52) U.S. Cl. 705/50

(57) ABSTRACT

A sponsor compensates an entity, such as a wireless service provider or an intermediary, in exchange for allowing the sponsor to advertise on a card, such as a phone card. The card, which is available for purchase by consumers, is used to purchase a wireless service. In some embodiments, the compensation paid by the sponsor to the entity subsidizes the cost of the wireless service for the consumer. In use, the card is coupled to an advertising-enabled wireless terminal. The advertising that appears on the card is visible to the user through the back cover of the wireless terminal. The sponsor card must remain coupled to wireless terminal for the consumer to use the service that was purchased via the sponsor card.

### FIELD OF THE INVENTION

The invention relates to wireless devices and methods for use with wireless devices.

### BACKGROUND OF THE INVENTION

Advertising is big business. In the United States alone, billions of dollars are spent annually to introduce new products and services, maintain sales of existing products, or simply to keep a company name in front of the public.

Advertising is usually intended to evoke, in the mind of a consumer, a positive message or feeling, and associate it with the advertiser's product or service. Ironically, consumer reaction to advertising is typically at odds with that goal.

In fact, the reality is that the consumers usually view advertising as an annoyance at best or with disdain at worst. Favorite television programs are interrupted on a regular basis by sponsors that are trying to sell something. Upwards of ninety percent of the traffic on the internet is SPAM, much of it advertising. Consumers are inundated with advertising. It's pushed at them and, for the most part, it's unwanted.

Regardless of a consumer's level of receptivity to an advertiser's message, the more the consumer sees the message, the more successful the advertising is likely to be. This is problematic for the advertiser because it's easy for the consumer to simply turn a page, change a station, or mute the volume to minimize exposure to advertising. And this is one reason why consumer distaste for unsolicited advertisements is a problem for the advertiser.

The effectiveness of any advertising campaign would improve if a way could be found to more positively dispose a consumer toward a particular advertiser, or towards advertising in general. In addition to increasing a general level of receptivity to advertising, consumers would tolerate more exposure to advertising.

### SUMMARY

The present invention provides a way to advertise that benefits the advertiser and the consumer alike. The advertiser benefits because the method (1) improves the receptivity of the consumer to its advertising and (2) increases the exposure of the consumer to the advertising. The consumer benefits because the method reduces the cost of a desired service.

In a business model in accordance with the illustrative embodiment of the present invention, a sponsor compensates an entity in exchange for receiving advertising from the entity. The advertising appears on a sponsor card, which is made available for purchase to consumers. The sponsor card is used, for example, to purchase a wireless service (e.g., 60 minutes of air-time, etc.). In such embodiments, the sponsor card is, effectively, a phone card with third-party advertising; that is, a sponsored phone card. In some embodiments, some portion of the compensation paid by the sponsor to the entity subsidizes the cost of the wireless service for the consumer.

In some embodiments, the “entity” that “provides” the advertising is a wireless service provider. In some other embodiments, the “entity” is an intermediary (rather than a wireless service provider) that purchases wireless minutes, etc., from a wireless service provider. Embodiments in which the entity is an intermediary define a new type of business, whereby a third party:
purchases a wireless service (e.g., air-time, etc.) from a wireless service provider;
accepts compensation from a sponsor for placing the sponsor's advertising (including an indicium of sponsorship) on a sponsored phone card; and
offers the sponsored phone card for sale to the public. In some embodiments, the sponsored phone card is offered for sale at a “discounted” rate, wherein the cost of the wireless service is subsidized by the some portion of the compensation that was paid by the sponsor.

In the illustrative embodiment, the sponsor card is inserted into a sponsor-card receiver in an advertising-enabled wireless terminal. The advertising that appears on the sponsor card is visible to the user through a relatively large “window” in the back cover of the advertising-enabled wireless terminal.

A sponsor will, of course, want the user to view the advertising that appears on the sponsor card for an extended period of time. This raises certain compliance issues. In particular:
A. How to prevent a situation in which a consumer buys a sponsor card to obtain subsidized wireless air time, but uses the air time with a standard wireless terminal rather than an advertising-enabled wireless terminal.
B. How to ensure that the sponsor card will be inserted into the advertising-enabled wireless terminal, so that a user will be exposed to the advertising.
C. How to ensure that when a sponsor card is purchased, that particular card, as opposed to a previously-purchased card, is inserted into the advertising-enabled wireless terminal.

In accordance with the illustrative embodiment, compliance issues A through C are addressed, and extended viewing of a sponsor's advertising is facilitated, by the following features:
1. The sponsor card can only be used with an advertising-enabled phone.
2. The sponsor card must be physically coupled to the wireless terminal for the advertising-enabled wireless terminal to be active.
3. The sponsor card has a physical key that embodies a code or pin that identifies the sponsor and must be read by the advertising-enabled wireless terminal and authenticated before an information module within the terminal (e.g., the SIM card, etc.) can be charged (e.g., with “wireless minutes”).
4. The advertising-enabled wireless terminal locks the SIM card with a code or “pin” that remains unknown to the user.

As to feature 1, an information string (e.g., a plurality of numbers, etc.) is provided with the sponsor card (e.g., printed on the sponsor card, etc.). Encrypted or otherwise hidden in that string is a code or “network pin” that is ultimately presented to the wireless service provider in conjunction with a user's request to charge an information module within the wireless terminal with the amount of time that was purchased (by buying the sponsor card).

Only an advertising-enabled wireless terminal, as disclosed herein, is capable of extracting the network pin. If a user were to enter the information string into a standard wireless terminal, and that string were transmitted to a wireless service provider, it would not be recognized as valid. As a consequence, to charge the information module with “minutes” that were purchased by buying the sponsor card, an advertising-enabled wireless terminal must be used.

As to feature 2, the advertising-enabled wireless terminal includes a sponsor-card receiver and a sponsor-card reader or sensor. Only when a sponsor card is sensed within the receiver does the advertising-enabled wireless terminal become active. This prevents a user from charging a SIM card, etc., removing the sponsor card and then continuing to use the advertising-enabled wireless terminal.

As to feature 3, in the illustrative embodiment, the sponsor card includes a “mechanical” or “physical” key, such as a plurality of “fingers” that depend from an end of the sponsor card or contacts that are disposed near an end of the sponsor card. This key embodies a code, which, in some embodiments, identifies the sponsor. A sponsor card reader within the wireless terminal (which can be the same device that initially senses the presence of the sponsor card and activates the wireless terminal) extracts the code from the key. A second code is manually input by a user into the wireless terminal using the keypad. In the illustrative embodiment, the code that is manually input is contained in the same information string that contains the network pin.

The two codes—the one extracted by the sponsor card reader and the other one that is input by the user—are compared. In other words, an authentication process is conducted, wherein a candidate authentication code (such as the extracted code) is compared against a code that is assumed to be valid (such as the code that is manually input). If the two codes match, then the advertising-enabled wireless terminal will permit a call to be placed to the wireless service provider to charge the information module (e.g., SIM card, etc.) with the service that has been purchased.

As to feature 4, in some embodiments, the advertising-enabled wireless terminal itself generates a code or pin for unlocking the information module. This pin remains unknown to the user. Each time the advertising-enabled wireless terminal is turned on, the terminal provides the PIN to unlock the SIM. In embodiments in which the information module is a SIM card, if the SIM were to be moved to a standard wireless terminal, the user would be queried for the PIN, since the standard wireless terminal will not (i.e., cannot) provide it. Since this PIN is not known to the user, the SIM could not be unlocked. This prevents a user from charging a SIM card in an advertising-enabled wireless terminal and then moving it to a standard wireless terminal.

The illustrative embodiment of the invention is a method for using a wireless terminal, wherein the method comprises unlocking an information module within said wireless terminal when a second code matches a first code, wherein:
(i) said wireless terminal generates said first code;
(ii) said first code is unknown to a user;
(iii) said wireless terminal provides said second code.
   In some embodiments, the information module is a SIM card.

In some embodiments, the method further comprises:

receiving a card in said wireless terminal;

obtaining a first code from a card, wherein said first code is embodied in a physical key of said card; and

comparing said first code to a second code associated with said card, wherein said second code is contained in an information string.

To the extent that advertising that appears on the sponsor card subsidizes the cost of wireless service, there is incentive for the consumer to purchase the card. This is expected to at least somewhat mollify any adverse inclinations that a consumer might harbor about viewing the advertising. In this way, the advertising is pulled to, rather than pushed at, consumers, and is expected to increase consumer receptivity to the advertising.

### BRIEF DESCRIPTION OF THE DRAWINGS

FIG. 1 depicts a first definition of method for advertising in accordance with the illustrative embodiment of the present invention.

FIG. 2 depicts a second definition of method for advertising in accordance with the illustrative embodiment of the present invention.

FIGS. 3A through 3D depict illustrative sponsor cards having an indicium of sponsorship and a mechanical key, wherein the key is a plurality of fingers.

FIGS. 3E and 3F depict variations of the sponsor cards depicted in FIGS. 3A through 3D, wherein the mechanical key comprises a plurality of holes and a plurality of contacts, respectively.

FIG. 3G depicts a sponsor card with an information string, wherein the information string comprises two sub-strings for a dual authentication process.

FIG. 4 depicts an advertising-enabled wireless terminal in accordance with the illustrative embodiment of the present invention.

FIG. 5A depicts a view of the back cover of an embodiment of the advertising-enabled wireless terminal of FIG. 4.

FIG. 5B depicts the back cover of the embodiment of the advertising-enabled wireless terminal of FIG. 5A, wherein a sponsor card is inserted in the advertising-enabled wireless terminal.

FIG. 6A depicts a view of the back cover of the embodiment of the advertising-enabled wireless terminal of FIG. 5A, wherein the battery cover is removed.

FIG. 6B depicts the battery cover that is removed from the advertising-enabled wireless terminal of FIG. 6A.

FIG. 7 depicts a cross-sectional view of an embodiment of the advertising-enabled wireless terminal of FIG. 4.

FIG. 8A depicts an information string that contains two authentication codes, wherein the codes are segregated from one another.

FIG. 8B depicts an information string that contains two authentication codes, wherein the codes are co-located.

FIG. 9A depicts an illustrative mechanical key of a sponsor card, wherein the key includes a plurality of fingers that embody an authentication code.

FIG. 9B depicts an information string that is associated with the sponsor card of FIG. 9A.

FIG. 10 depicts a method for activating an advertising-enabled wireless terminal in accordance with the illustrative embodiment of the invention.

### DETAILED DESCRIPTION

Definition

The terms listed below are defined for use in this Specification. Other terms will be defined throughout the Specification, as opportunity and context permits. “Wireless terminal” means wireless telecommunications-enabled electronics devices. This includes phones, personal digital assistants, pagers, etc. The wireless terminal can use any access technology (e.g., frequency division multiple access, time-division multiple access, time-division duplex, code-division multiple access, etc.) and any modulation scheme (e.g., frequency shift keying, quadrature phase-shift keying, etc.) in accordance with any interface (e.g., IS-41, IS-54, IS-95, GSM, etc.). Furthermore, a wireless terminal can transmit and receive at any frequency (e.g., 800 MHz, 1800 MHz, etc.).

“Information module” means any arrangement of logic and memory, implemented as either special-purpose hardware or programmed general-purpose hardware or both, that stores and/or processes information concerning a subscriber/user, device settings, security keys, or other data necessary for the functioning of a wireless terminal. Examples of an information module include, without limitation, (1) a SIM card; and (2) logic and memory that provides the functionality of a SIM card, as would be found in the processor, memory, and control circuitry of a non-GSM wireless terminal.

“Sponsor” means any entity that pays to advertise with a wireless service provider or other entity. Due to cost considerations, the sponsor will typically be a large corporation, but there are no prohibitions in this regard, except that the term

“sponsor” is defined to exclude the wireless service provider itself. Usually, the sponsor will not be the manufacturer of the wireless terminal nor a seller. (retailer) of wireless terminals. In other words, the sponsor will usually be a third party that is not associated with the operation (service provider), manufacture (manufacturer), or sale (wireless-terminal retailer) of a wireless terminal. Typically, but not necessarily, the compensation that is provided to the entity that provides the advertising is in the form of money.

“Advertising” means something that calls attention to the sponsor. That is, advertising is a representation that a consumer recognizes, or will come to recognize, as being in some way associated with the sponsor.

“Indicium of sponsorship” or “indicium of a sponsor” refers to a visual representation that serves as advertising for the sponsor. For example, the representation can be the name of the sponsor, a brand name, a slogan, a logo, an insignia, a symbol, a product of the sponsor, or any combination thereof. Literally anything that is associated with the sponsor or one of its products or services, or anything that could ultimately become so associated, can serve as advertising.

Overview

The present invention provides, without limitation:

a new method for advertising;
a new business method;
an advertising-enabled wireless terminal; and
compliance/authentication methods that are useful in conjunction with the advertising method and advertising-enabled wireless terminal, as well as other applications.

The illustrative advertising method and new business method are described below in the sub-section entitled “ADVERTISING AND SPONSORSHIP.” The methods are practiced using a “sponsor card” and an “advertising-enabled wireless terminal.” In the illustrative embodiment, the sponsor card is a phone card, as described in further detail in the sub-section entitled “SPONSOR CARD.” In the illustrative embodiment, the advertising-enabled wireless terminal contains a SIM card, suitably modified as described under the sub-section entitled “ADVERTISING-ENABLED WIRELESS TERMINAL.”

The illustrative method and its use in conjunction with an advertising-enabled wireless terminal raises certain compliance and authentication issues. These issues, and methods and articles for addressing them, are described under the sub-section entitled “COMPLIANCE AND AUTHENTICATION.”

Advertising and Sponsorship

In accordance with the illustrative embodiment of the present, a sponsor compensates an entity in exchange for that entity displaying ,the sponsor's advertisement, including its indicium of sponsorship.

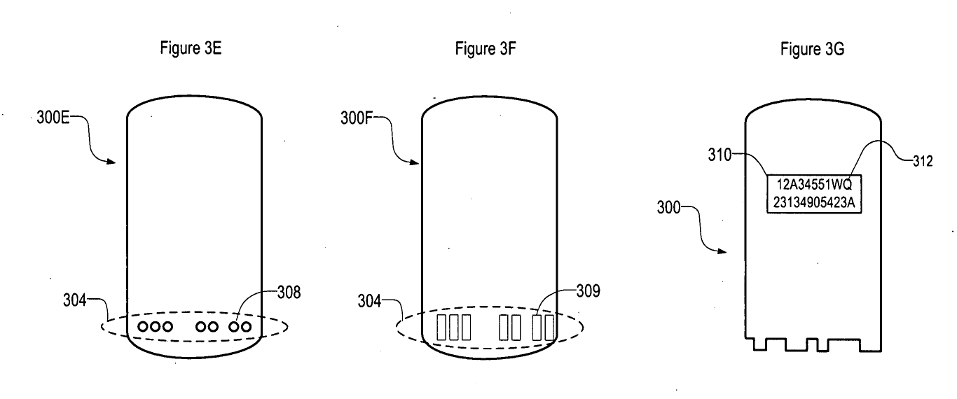

In the illustrative embodiment, the advertising and indicium of sponsorship appears on a “sponsor card.” The card is available for purchase by consumers and is used in conjunction with an advertising-enabled wireless terminal, as described herein. In some embodiments, the sponsor card is used to purchase a wireless service for the advertising-enabled wireless terminal. The sponsor card is described in further detail later in this Specification under the sub-section entitled “Sponsor Card” and in conjunction with FIGS. 3A through 3G.

In the illustrative embodiment, the sponsor card is a phone card, which enables a consumer to obtain air time or “minutes” from a wireless service provider for use with the advertising-enabled wireless terminal.

Phone cards have been in use for years (although they typically do not included third-party advertising). Conventionally, the purchaser of a phone card enters a code that is associated with the card into their wireless terminal and transmits the code to the appropriate wireless service provider. After an authentication process, the wireless service provider transmits an authorization to the wireless terminal for the amount of air time purchased. The authorization is stored/processed by an information module (e.g., SIM card, etc.) The phone card is then discarded.

Placing an advertisement on a phone card that will be discarded soon after it is purchased would be of dubious value to a potential advertiser. In accordance with the illustrative embodiment of the present invention, the sponsor card (e.g., phone card, etc) cannot be discarded immediately after purchase. Rather, in accordance with the illustrative embodiment of the invention, the sponsor card must be physically coupled to the advertising-enabled wireless terminal. The wireless terminal is not operable unless the sponsor card is coupled to it. And as long as the sponsor card is coupled to the wireless terminal, the advertising and indicium of sponsorship remains visible to its user.

Since the sponsor card must be physically coupled to the advertising-enabled wireless terminal for the terminal to operate, and the inidicium of sponsorship is discernable while the card is physically coupled to the wireless terminal, the consumer will be exposed to the advertising for an extended period of time. Continued exposure to the sponsor's advertising is expected to increase the effectiveness of the advertising.

In the illustrative embodiment, the compensation that is paid by the sponsor to the entity that places the advertising on the sponsor card subsidizes the price of a wireless service for the consumer. In other words, the consumer pays less for air time by virtue of the fact that they have purchased a sponsor card on which a sponsor's advertising appears. The consumer therefore has an incentive to subject himself or herself to the sponsor's advertising—the incentive being cheaper wireless service. In this way, the advertising is pulled to, rather than pushed at, the consumer. It is expected that this “pull to” approach will improve consumer acceptance of and receptivity to a sponsor's advertisement.

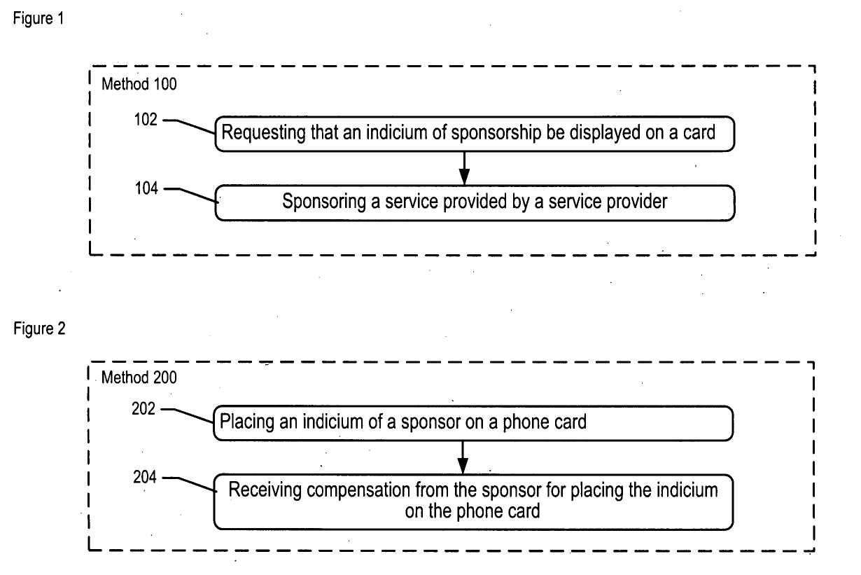

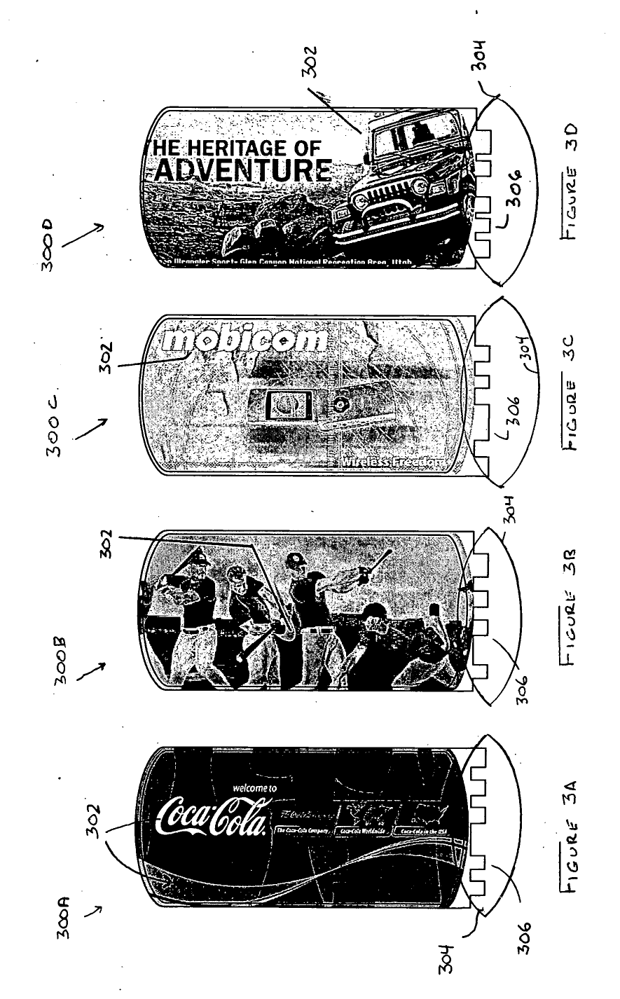

FIG. 1 depicts method 100A and FIG. 2 depicts method 100B for advertising. Both of these methods are in accordance with the illustrative advertising method described above, but define it from different perspectives. In particular, method 100A recites operations that are performed by a sponsor while method 100B recites operations that are performed by the entity that receives compensation for placing the sponsor's advertising on the sponsor card.

Operation 102 of method 100A recites:
Requesting that an indicium of sponsorship be displayed on a card, wherein:
   (i) the card is available for purchase; and
   (ii) paying a purchase price of the card entitles a purchaser thereof to receive an amount of service, from a service provider, for use with a wireless terminal.
      Operation 104 of method 100A recites:
Sponsoring the service by compensating the entity that provides the card with the indicium of sponsorship.

In some embodiments, the “entity” in method 100A is a wireless service provider. In such embodiments, the wireless service provider receives compensation from a sponsor in exchange for placing the sponsor's advertising on a phone card, thereby created a sponsor card.

In some other embodiments, the “entity” is an intermediary that purchases minutes from a wireless service provider. In this latter case, in exchange for receiving compensation from a sponsor, the third party will place the sponsor's advertising on a sponsor card and make the'cards available for purchase to the public.

In some embodiments, a portion of the compensation that an entity receives for placing the advertising for the benefit of a sponsor is used to reduce the cost of the card to a buyer.

For example, assume that an entity has a block of PIN numbers, wherein each PIN number authorizes $50 worth of wireless air time. The entity accepts $5 to place a sponsor's advertising, including its indicium of sponsorship, on each card. Assume that it costs the entity $1.50 to place the advertising on each card. At its discretion, the entity decides to discount the card by $2.

As a consequence, a purchaser would pay $50−$2=$48 for $50 worth of air time. And the entity, whether it is a wireless service provider or an intermediary, has made an additional $5.00−$1.50−$2.00=$1.50 per card that it sells.

Operation 202 of method 100B recites:

Placing an indicium of a sponsor on a phone card.

Operation 204 of method 100B recites:
Receiving compensation from the sponsor for placing the indicium on the phone card.

It is to be understood that typically, the “entity” (e.g., intermediary, wireless service provider, etc.) does not actually place the indicium of sponsorship on the card. Rather, the entity directs a printer, etc., to produce the card. As used in this Specification, including the appended claims, the phrase “placing an indicium of sponsorship (a sponsor) on a card” means either:
(1) actually producing the card and placing the indicium of sponsorship on the card; or, more typically,
(2) directing a printer or other appropriate party to produce the card with the indicium of sponsorship.

Sponsor Card

As disclosed above, a sponsor card displays a sponsor's “indicium of sponsorship.” The card is available for purchase by consumers and, in the illustrative embodiment, enables a consumer to purchase an amount of a service from a wireless service provider. The service purchased by the consumer is for use in conjunction with an advertising-enabled wireless terminal.

FIGS. 3A-3D depict exemplary sponsor cards 300A, 300B, 300C, 300D, which are collectively or generically referred to as sponsor card(s) 300. Each card includes at least one indicium of sponsorship 302. For card 300A depicted in FIG. 3A, the sponsor is the Coca Cola Company and indicium of sponsorship 302 is the brand name, “Coca Cola®,” which is reproduced in the characteristic stylized font. Furthermore, the characteristic wavy line that appears on Coca Cola products is reproduced on the card, and this also serves as indicium of sponsorship 302.

For card 300B depicted in FIG. 3B, the sponsor is Nike, and the indicum of sponsorship 302 is their logo—the Nike “swish.” In addition to the indicium of sponsorship, the card also depicts a sports activity, baseball in this case, which is of course related to Nike's product lines.

For card 300C depicted in FIG. 3C, the sponsor is Mobicom and the indicium of sponsorship 302 is the company name. The advertising also includes an image of a wireless terminal, which is appropriate since Mobicom is a manufacturer of wireless terminals. As noted under the “Definitions” section, the sponsor will typically not be connected with the operation, manufacture, or sale of wireless terminals. But the definition of “sponsor” does not explicitly exclude manufacturers or sellers of wireless terminals.

For card 300D depicted in FIG. 3D, the sponsor is Jeep and the indicium of sponsorship 302 is one their products—the Jeep Wrangler®. The phrase “The heritage of Adventure” and a rocky trail are also depicted on the card, the intent being to associate ruggedness, etc., with the Jeep Wrangler® vehicle.

In the illustrative embodiment, indicium of sponsorship 302 and any associated graphics completely fill one side of sponsor card 300. In some embodiments, a second indicium of sponsorship appears on the other major surface (i.e., the flip side) of sponsor card 300. In some cases, both indicium of sponsorship are for the same sponsor. In some other cases, the indicium of sponsorship appearing on the two major surfaces of the sponsor card are for different sponsors.

In some additional embodiments, sponsor card 300 comprises a lenticular image. A lenticular image displays two or more images as the angle of viewer with respect to the image changes. Using a lenticular image, two or more different indicium of sponsorship can be displayed on a single side of the sponsor card, either for a single sponsor or multiple sponsors.

Sponsor card 300 also includes mechanical or physical key 304 in which information is encoded or otherwise embodied. In each of illustrative sponsor cards 300, mechanical key 304 is a plurality of “fingers” 306, which depend from an end the sponsor card. In some other embodiments, mechanical key 304 is some other structural feature. For example, in sponsor card 300E that is depicted in FIG. 3E, mechanical key 304 is a plurality of “holes” 308. In sponsor card 300F depicted in FIG. 3F, key 304 is a plurality of “contacts” 309. The contacts can be deposited or otherwise imprinted on the surface of sponsor card 300, typically near an end of the card.

The presence or absence of a physical feature (e.g., fingers 306, holes 308, contacts 309, etc.) of mechanical key 304 at particular location can be used to embody or encode information. A reader or sensor in the advertising-enabled wireless terminal is used to extract the information by physically engaging or otherwise sensing the presence or absence of the feature of mechanical key 304 at a particular location. Embodying information in mechanical key 304 of phone card 300 is described in further detail in the sub-section entitled “COMPLIANCE AND SECURITY.” The reader or sensor is described in further detail in the sub-section entitled “ADVERTISING-ENABLED WIRELESS TERMINAL.”

As depicted in FIG. 3G, sponsor card 300 also includes information string 310. In the illustrative embodiment, information string 310 is embodied as a plurality of characters that are printed on label 312. In embodiments of sponsor card 300 in which only one side of the sponsor card includes an indicium of sponsorship, label 312 is advantageously, but not necessarily, attached (e.g., temporary adhesive, etc.) to the side of the card that does not bear the indicium of sponsorship.

In some other embodiments, information string 310 is printed directly on sponsor card 300. In yet some further embodiments, information string 310 is printed on packaging, etc., for sponsor card 300, rather than on the card itself.

The phrase “associated with,” when used to describe the relationship between information string 310 and sponsor card 300, encompasses any of the scenarios described above. That is, information string 310 can be on a label that is attached to sponsor card 300, it can be embodied directly on sponsor card 300 (e.g., printed on the card, etc.), or it can be attached to packaging, if any, that accompanies the sponsor card.

As described later in this Specification under the sub-section “COMPLIANCE and SECURITY,” in the illustrative embodiment, information string 310 includes two information sub-strings. The sub-strings are used for different authentication processes.

It is notable that sponsor card 300 is passive. That is, it includes no logic or addressable memory capabilities. In the illustrative embodiment, the information that is embodied on sponsor card 300 is input both manually (via a keypad) and automatically (via a reader) into a buffer within the advertising-enabled wireless terminal.

### Advertising-Enabled Wireless Terminal

An “advertising-enabled wireless terminal” provides wireless telecommunications capability and is, therefore, capable of transmitting and receiving both voice and data with wireless base stations (not shown) or other wireless terminals or both. Furthermore, an advertising-enabled wireless terminal is configured so that:
it can physically receive a sponsor card;
it will not be fully operational unless the sponsor card is physically coupled to the wireless terminal; and
the indicium of sponsorship (i.e., the advertising) that appears on the card remains visible to the user of the advertising-enabled wireless terminal as long as the sponsor card is physically coupled to it.

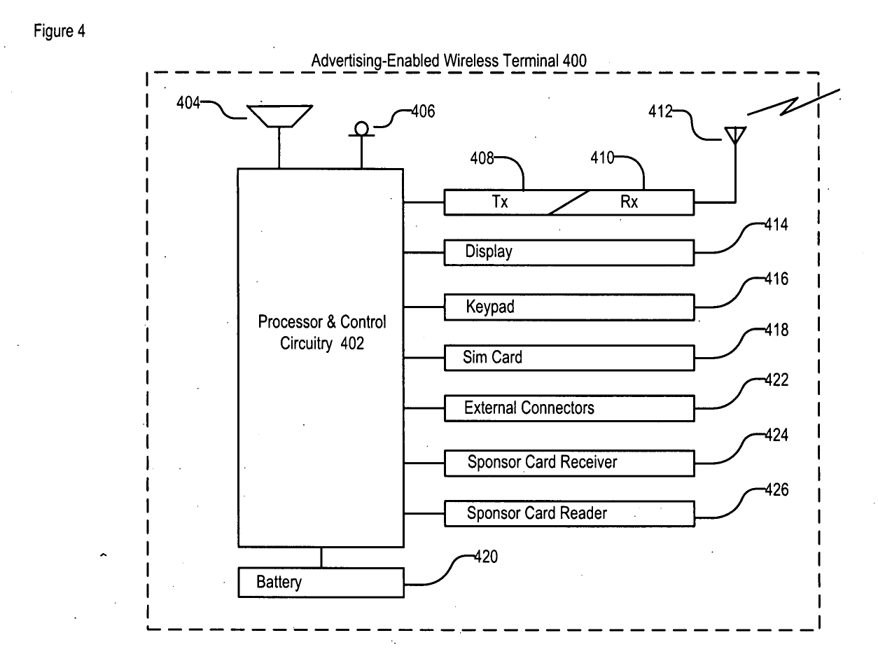

FIG. 4 depicts a block diagram of the salient components of advertising-enabled wireless terminal 400.

Advertising-enabled wireless terminal 400 comprises: processor/control circuitry 402, speaker 404, microphone 406, transmitter 408, receiver 410, antenna 412, visual display 414, keypad 416, subscriber identity module (“SIM”) 418, battery 420, external connectors 422, sponsor card receiver 424, and sponsor card reader 426. Since components 402 through 422 are found in conventional phones and are well understood, they will be described only briefly.

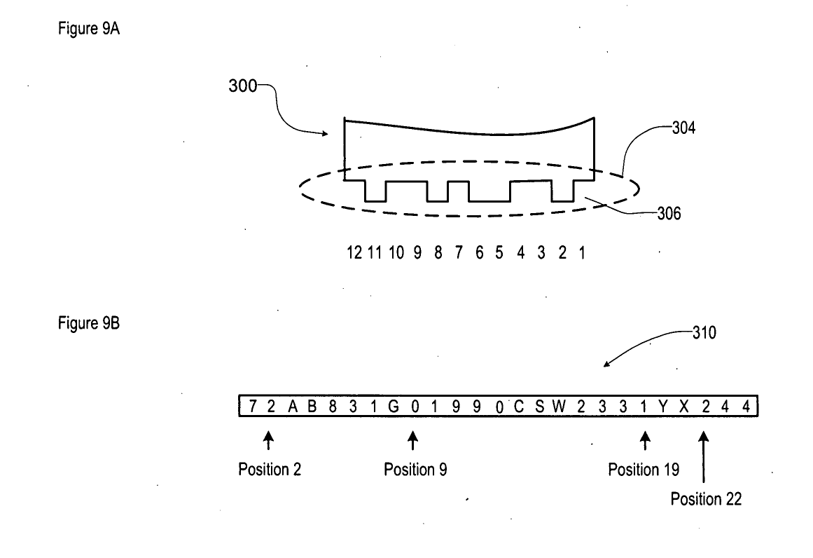

Processor/control circuitry 402 is capable of coordinating and controlling the other components of wireless terminal 400 to provide wireless telecommunications capability. Furthermore, processor/control circuitry 402 performs some of the operations depicted in method 900 (see, FIG. 9). Control circuitry 402 can comprise special-purpose hardware or programmed general-purpose hardware or both.

Speaker 404 is capable of outputting an acoustic signal (e.g., the speech of another person, an alerting or ringing signal, etc.) to a user of wireless terminal 400 in well-known fashion. Microphone 406 is capable of receiving an acoustic signal (e.g., the speech of the user of wireless terminal 400, etc.) and of conveying it to processor/control circuitry 402 for conversion to a digital signal.

Transmitter 408, receiver 410, and antenna 412 provide wireless telecommunications capability at radio frequencies to wireless terminal 400 in known fashion.

Display 414 is a visual display that enables wireless terminal 400 to output information (e.g., text, images, video, etc.) to a user. Typically, display 414 can be illuminated to enhance viewing as desired. Keypad 416 is a tactile input device that enables wireless terminal 400 to receive information from a user.

Battery 420 is an energy-storage device (e.g., an electro-chemical energy-storage device, etc.) that provides energy to processor/control circuitry 402 and the other components of wireless terminal 400 in well-known fashion.

External connectors 422 enable a user to connect wireless terminal 400 to any of a number of external devices, such as a battery charger, a car-kit, etc.

Advertising-enabling wireless terminal 400 is depicted as including Subscriber Identity Module (SIM) 418. GSM-compliant wireless terminals and some non-GSM-compliant wireless terminals (such as CDMA phones in China) include a SIM, which is often referred to as a “SIM card.”

SIM card 418 is a “smart card” that holds all of a subscriber's personal information, the phone number, phone settings, personal security key, and other data necessary for a handset to function. Essentially, it is the subscriber's authorization to use the wireless network. Generally, the SIM card can be switched from wireless terminal to wireless terminal, letting a new terminal receive all calls to the subscriber's number. Although, as described later in this Specification, the ability to move a SIM card from advertising-enabled wireless terminal 400 to a conventional wireless terminal is restricted (i.e., made intentionally problematic to discourage such behavior).

A wireless terminal that has a SIM also includes a SIM card reader, which is incorporated in processor/control circuitry 402. The SIM card reader reads the subscriber information that is contained on the SIM card. This information is then transmitted to the network.

Wireless terminals that do not include a discrete, removable SIM card provide, in the memory and logic of processor/control circuitry 402, much of the same type of information and functionality as would otherwise be provided in the SIM. As indicated under the sub-section entitled “Definitions,” the term “information module” covers both a SIM card and its functional equivalent in the memory and logic of processor/control circuitry 402 of a wireless terminal that does not contain a SIM.

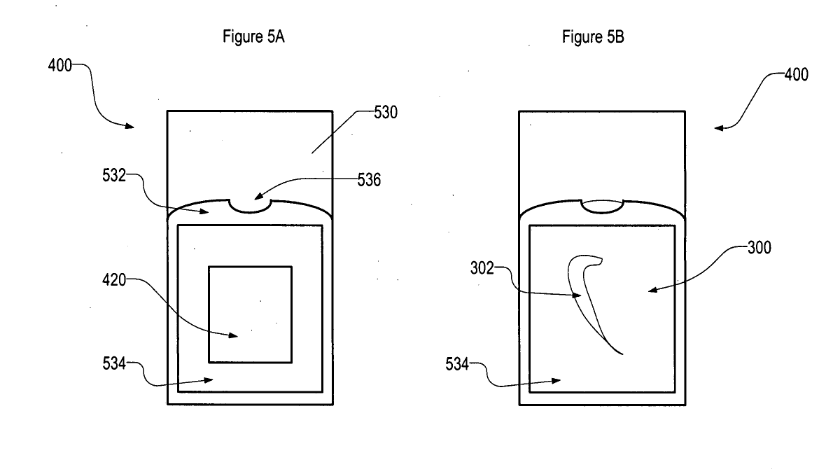

Unique to advertising-enabled wireless terminal 400 is the ability to accept sponsor card 300, sense its presence, and extract information from it. To receive sponsor card 300, advertising-enabled wireless terminal 400 includes sponsor card receiver 424. To sense the presence of sponsor card 300 and to extract information that is embodied on it, wireless terminal 400 includes sponsor card reader 426. The sponsor card receiver and sponsor card receiver are described further below in conjunction with FIGS. 5A-5B, 6A-6B, and 7.

FIGS. 5A and 5B depict a view of the back of advertising-enabled wireless terminal 400. FIG. 5A depicts advertising-enabled wireless terminal 400 without a sponsor card in its sponsor card receiver 424, while FIG. 5B depicts the wireless terminal with sponsor card 300 in place.

Referring now to FIG. 5A, battery cover 532 removably couples to rear housing 530. Battery cover 532 includes transparent region or window 534. When a sponsor card is not in sponsor card receiver 424, as is the case in FIG. 5A, battery 420 is visible through window 534. Battery cover 532 also includes thumb tab 536, which facilitates removal of a sponsor card.

FIG. 5B depicts advertising-enabled wireless terminal 400 with sponsor card 300 in sponsor card receiver 424. As a consequence, the sponsor card, and, most importantly, indicium of sponsorship 302, is visible through window 534.

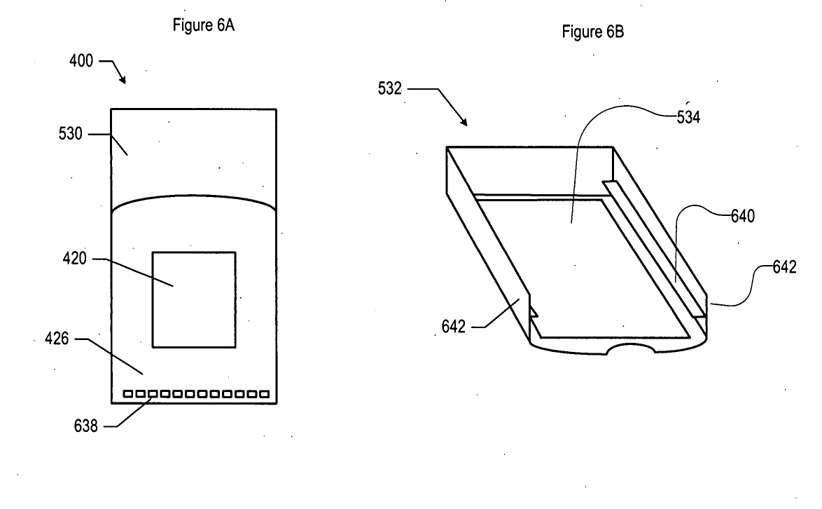

FIG. 6A depicts advertising-enabled wireless terminal 400 with battery cover 532 removed. Battery 420 and sponsor card reader 426 are visible within rear housing 530.

In accordance with the illustrative embodiment, advertising-enabled wireless terminal 400 is inoperable if sponsor card 300 is not present in sponsor card receiver 424. It will be appreciated by those skilled in the art that there are many ways to implement this functionality. For example, a simple switch arrangement can be used wherein, when sponsor card 300 is present, it depresses or otherwise moves electromechanical contacts to close a switch, etc., that activates the wireless terminal. In some other embodiments, more sophisticated sensor arrangements (e.g., optical, magnetic, etc.) can suitably be used. In some of these other embodiments, a specific marker, etc., is embodied on sponsor card 300 for detection by the sensor. The marker is advantageously inconspicuous or otherwise hidden in a larger graphic or image that appears on sponsor card 300. If only one side of the sponsor card bears an indicium of sponsorship, then the marker will advantageously appear on the other side of the card. If both sides include an indicium of sponsorship, then a marker should appear on both sides of the card.

In the illustrative embodiment, the above-described detection functionality, as well an authentication functionality, is performed by sponsor card reader 426. In the embodiment that is depicted in FIG. 6A, sponsor card reader 426 comprises a plurality of mechanical contacts 638. As described later in further detail, “fingers” that depend from the sponsor card impinge upon some of mechanical contacts 638. Each mechanical contact that is impinged upon by a finger results in the transmission of a “high” signal (5y, etc.) to processor/control circuitry 402. In some embodiments, when processor/control circuitry 402 receives a high signal, it activates the general functions of advertising-enabled wireless terminal 400.

If a mechanical contact 638 is not impinged upon (because there is no finger at a particular location), then a “low” signal is transmitted to processor/control circuitry 102. In this way, information that is embodied or encoded by the position and presence of a given finger on sponsor card 300 is read by sponsor card reader 426 and transmitted to processor/control circuitry 402 within advertising-enabled wireless terminal 400. As described later in the sub-section entitled “COMPLIANCE AND SECURITY,” using the information extracted form sponsor card 302 and a code or “PIN” that is input by a user, processor/control circuitry 402 makes a determination as to the authenticity of a sponsor card.

In some embodiments in which mechanical key 304 is a plurality of holes 308 (see, FIG. 3E), sponsor card reader 426 comprises a plurality of pins (not depicted). The pins align with holes 308, and, to the extent that a hole is present at any given location, a pin will extend through the hole to engage a contact. Like the finger/contact arrangement described above, a “high” or “low” signal is sent as a function of whether or not there is a hole at a particular location. In some alternative embodiments, sponsor card reader 426 can be an optical scanner for reading the pattern of holes 308. In some embodiments in which key 304 comprises a plurality of contacts 309 (see, FIG. 3F), sponsor card reader 426 comprises a plurality of contacts that are suitably positioned to engage contacts 309; to the extent that a contact 309 is present at any given position. Like the other arrangements described above, a “high” or “low” signal is sent as a function of whether or not there is a contact 309 at a particular location. In some other embodiments, various electromagnetic or optical sensors are used to detect the presence or absence of contacts 309 at any particular location.

In some alternative embodiments, reader 426 is implemented as a sensor that 'simply detects whether or not sponsor card 300 is present within sponsor card receiver 424.

FIG. 6B depicts the underside of battery cover 532. Lip 640 depends from the inner surface of sidewalls 642. Lip 640 is the illustrative embodiment of sponsor card receiver 424. The sponsor card is inserted between the top of battery cover 532 (i.e., proximal to window 534) and lip 640. In the illustrative embodiment, sponsor card receiver 424 is designed so that battery cover 532 must be removed to insert sponsor card 300. In some other embodiments (not depicted), sponsor card 300 can be inserted or removed without removing battery cover 532.

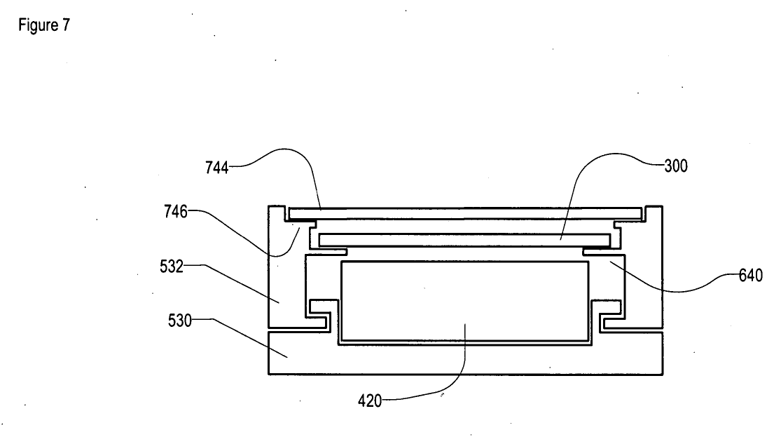

FIG. 7 depicts a cross section through advertising-enabled wireless terminal 400. This FIG. depicts the wireless terminal with battery cover 532 engaged to rear housing 530. In the embodiment depicted, transparent material 744, such as glass, plastic, etc., resides in window 534, supported by and bonded to (e.g., adhesive, ultra sonic welding, etc.) shoulder 746. Sponsor card 300 is supported by lip 640 between battery 420 and transparent material 744.

Compliance and Security. Several compliance and security issues arise in conjunction the illustrative advertising method and the advertising-enabled wireless terminal. These issues, which are identified below, arise from a sponsor's desire for the consumer to be exposed to the sponsor's advertising for as long as possible. The compliance issues include:
A. How to prevent a situation in which a consumer buys a sponsor card to obtain subsidized wireless air time, but uses the air time with a standard wireless terminal, rather than an advertising-enabled wireless terminal.
B. How to ensure that the sponsor card will remain in the advertising-enabled wireless terminal, so that a user will be exposed to the advertising.
C. How to ensure that when a sponsor card is purchased, that particular card, as opposed to a previously-purchased card, is inserted into the advertising-enabled wireless terminal. This issue might arise, for example, if a sponsor heavily subsidizes a wireless service and has a particularly unattractive or uninteresting sponsor card. If the user has a previously-purchased sponsor card with a more desirable advertising graphic, the user might to prefer to insert this older sponsor card into the terminal. In this situation, the sponsor's advertising dollars are wasted.

In accordance with the illustrative embodiment, compliance issues A through C are addressed, and extended viewing of a sponsor's advertising is facilitated, by the following features:
1. The sponsor card can only be used with an advertising-enabled phone.
2. The sponsor card must be physically coupled to the wireless terminal for the wireless terminal to be active.
3. The sponsor card has a mechanical key that embodies a code or pin that identifies the sponsor and must be read by the advertising-enabled wireless terminal and authenticated before the information module can be charged.
4. The advertising-enabled wireless terminal locks the SIM card with a code or “pin” that remains unknown to the user.

Feature 2 has already been described. Features 1, 3, and 4 are now described in further detail.

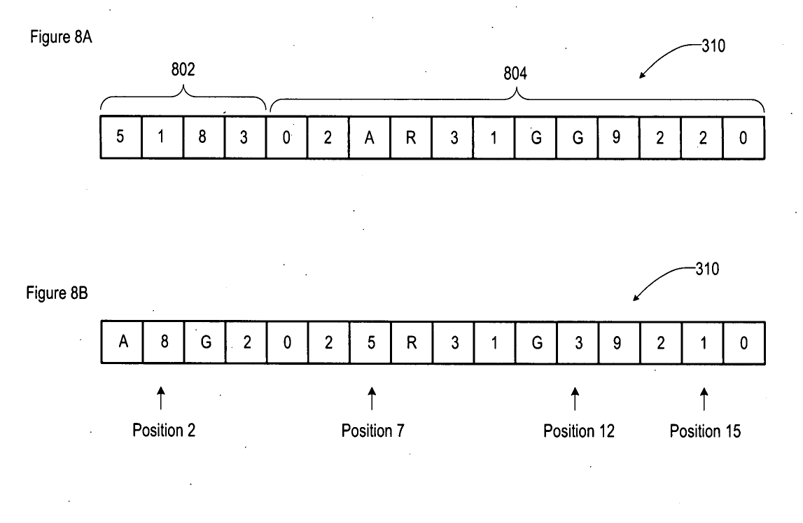

As to features 1 and 3, an information string is associated with the sponsor card (e.g., printed on the sponsor card, etc.). This was previously described in conjunction with FIG. 3G (see, information string 310). FIGS. 8A and 8B depict further detail of information string 310. In particular, as depicted in FIG. 8A, information string 310 includes two codes or pins 802 and 804 that are encrypted or otherwise hidden. One of the codes, which is embodied in first sub-string 802, is ultimately used in an authentication process with mechanical key 304. The other code, which is embodied in second sub-string 804, serves as a “network pin” that is ultimately presented to the wireless service provider in conjunction with a user's request to charge an information module with the amount of time that was purchased (by buying the sponsor card).

In some embodiments, such as the one depicted in FIG. 8A, the characters that compose respective first sub-string 802 and second sub-string 804 are segregated from one another. In embodiments in which the first and second sub-strings are segregated, the authentication codes embodied in those sub-strings are advantageously encrypted.

In some other embodiments, such as the one depicted in FIG. 8B, the alphanumeric characters that compose respective first sub-string 802 and second sub-string 804 are co-mingled. This “transposition” of characters provides a measure of encryption, such that the further encryption (i.e., substitution) might not be necessary.

With sponsor card 300 already in advertising-enabled wireless terminal 400, a user enters information string into terminal 400 using, for example, keypad 416.

Advertising-enabled wireless terminal 400 decrypts information string 310, extracting first sub-string 802 and second sub-string 804. As an illustration, information string 310 is assumed to be encoded in the manner depicted in FIG. 8B. Processor and control circuitry 402 decrypts information string 310 by extracting the first character of first sub-string 802 (a “5”from position 7, the second character (a “1”from position 15, the third character (an “8”from position 2, and the fourth character (a “3”from position 12.

In this example, it is assumed that second sub-string 804 is not encoded (other than by position), and the characters “AG202R31G920” are extracted in the order in which they appear in information string 310.

In the examples depicted in FIGS. 8A and 8B, information string 310 comprises 16 characters. It will be understood that in some other embodiments, fewer characters or, more typically, a greater number of characters are used in the information string. For example, in some embodiments, information string 310 comprises 24 characters.

It will be appreciated that only an advertising-enabled wireless terminal, as disclosed herein, is capable of extracting second sub-string 804 (i.e., the network pin). If a user were to enter information string 310 into a standard wireless terminal, and that string were transmitted to a wireless service provider, it would not be recognized as valid (since first sub-string 802, which is not a part of the network pin, would be transmitted as well). As a consequence, to charge an information module, etc., with “minutes” that were purchased by buying the sponsor card, an advertising-enabled wireless terminal must be used.

As previously described, sponsor card 300 includes mechanical key 304, which, in the illustrative embodiment, is realized as a plurality of “fingers” that depend from an end of the sponsor card. This key embodies a code, which, in some embodiments, identifies the sponsor. Sponsor-card reader 426 extracts the code from the key.

The two codes—the one embodied in key 304 and the other embodied in sub-string 802—are compared within processor and control circuitry 402. In other words, an authentication process is conducted, wherein a candidate authentication code (such as the extracted code) is compared against a code that is assumed to be valid (such as the code that is manually input). If the two codes match, advertising-enabled wireless terminal 400 will permit a call to be placed to the wireless service provider to charge an information module with the service that has been purchased.

The use of mechanical key 304 and the authentication process ensures that the sponsor card that was purchased to obtain a wireless service is the sponsor card that is inserted into advertising-enabling wireless terminal 400 to charge the information module. In other words, a consumer cannot insert an “old-favorite” sponsor card into advertising-enabling wireless terminal 400 and input the information string from a new sponsor card into wireless terminal 400 (which includes the network code for receiving wireless service). This protects the sponsor's investment in the advertising.

The following example provides further description of the manner in which a code is embodied in mechanical key 304 of sponsor card 300 and the manner in which it is authenticated. In the illustrative embodiment, mechanical key 304 is a plurality of fingers 306 (see, FIGS. 3A-3D). Each finger can be used to code a “1” (“high” voltage value) or a “0” (“low” voltage value). For a sponsor card having, for example, 12 fingers, over 4000 numbers—from 1 to 4095—(2¹²) can be coded.

FIG. 9A and Table 1 illustrate one way in which a code is embodied in mechanical key 304 of a sponsor card.

TABLE 1
Code Embodied in Mechanical Key of FIG. 9A

| LOCATION | 1 | 2 | 3 | 4 | 5 | 6 | 7 | 8 | 9 | 10 | 11 | 12 | TOTAL |
|---|---|---|---|---|---|---|---|---|---|---|---|---|---|
| Numeral | 1 | 2 | 4 | 8 | 16 | 32 | 64 | 128 | 256 | 512 | 1024 | 2048 | |
| Coded | | | | | | | | | | | | | |
| Location | | 1 | | | 1 | 1 | | 1 | | | 1 | | 1202 |
| of Fingers | | | | | | | | | | | | | |

In this illustration, mechanical key 304 is allotted space for a maximum of twelve “fingers” 306. The mechanical key that is depicted in FIG. 9A has five fingers, which are present at locations 2, 5, 6, 8, and 11. In this embodiment, the arrangement of fingers in key 304 codes a binary number. The “valid” authentication code that is embodied in first sub-string 802 of information string 310 is a decimal number. Table 1 depicts the extraction of the code that is embodied in mechanical key 304 and its conversion to a decimal number. As shown in Table 1, this particular arrangement of fingers 306 codes the numeral “1202.”

In some other embodiments, the code that is embodied in mechanical key 304 is further encrypted, such that a “key” is required for decryption. The key could be, for example, provided by the valid authentication code; that is, first sub-string 802.

FIG. 9B depicts information string 310, which is associated with the sponsor card having the mechanical key of FIG. 9A. The information string is entered by a user into advertising-enabled wireless terminal 400. Processor and control circuitry 402 decrypts the code that is embodied in the first sub-string. By way of illustration, not limitation, the code is decrypted by extracting the first digit of the code (“1”from position 19, the second digit of the code (“2”from position 22, the third digit of the code (“0”from position 9, and the fourth digit of the code (“2”from position 2. In some other embodiments, other schemes for encryption and decryption are used.

The code that is extracted from mechanical key 304 is then compared (presented) to the entered code, as decrypted. If the two codes match, then advertising-enabled wireless terminal 400 will permit the network code to be transmitted to the network to charge the information module.

An issue arises for embodiments in which advertising appears on both sides of sponsor card 300. If a single mechanical key 304 is used, then as the card if flipped to display one or the other of the faces, a different number (candidate authentication code) will be coded by the fingers, etc., that define the mechanical key. That is, the position of fingers is shifted as the card is flipped.

In such embodiments, processor and control circuitry 402 must change the “valid” authentication code (i.e., the code from first sub-string 802) to account for the change in the candidate authentication code that occurs when the sponsor card is flipped. This is within the capabilities of those skilled in the art. Alternatively, a third sub-string can be incorporated in information string 310, wherein the third sub-string provides the valid authentication code for the mechanical key when the card is flipped.

As an alternative to accounting for the change in the candidate authentication code, a second mechanical key is disposed on the other end of the sponsor card from the first mechanical key. If this second key has the same code as the first key, then a single “valid” authentication is required. If, however, the second key embodies a different code than the first mechanical key, an additional “valid” authentication code for comparison against the code extracted from the second mechanical key is required. As described above, this additional valid authentication code can be provided as a third sub-string in information string 310.

As to feature 4, in some embodiments, advertising-enabled wireless terminal 400 itself generates a code or pin for unlocking the information module (e.g., SIM, etc.). This pin remains unknown to the user. Each time the advertising-enabled wireless terminal is turned on, the terminal provides the PIN to unlock the SIM. If the SIM were to be moved to a standard wireless terminal, the user would be queried for the PIN, since the standard wireless terminal will not provide it. Since this PIN is not known to the user, the SIM could not be unlocked. This prevents a user from charging a SIM card in an advertising-enabled wireless terminal and then moving it to a standard wireless terminal.

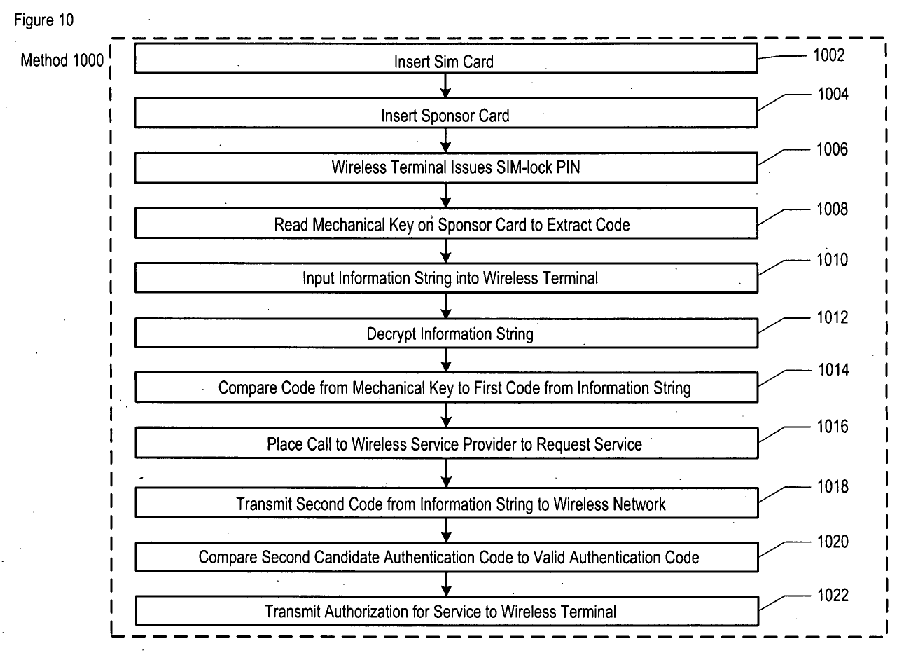

The various authentication and initialization operations that have been disclosed above are summarized below by way of method 1000, as depicted in FIG. 10. The operations of method 1000 are not performed by a single entity, but, rather, depending upon the nature of the operation, are performed by a consumer/user, advertising-enabled wireless terminal 400 (or an information module contained therein), or the wireless service provider. It should be understood that some of the operations of method 1000 can be performed in a different order than depicted.

In operation 1002, a SIM card is inserted into advertising-enabled wireless terminal 400. This operation is performed in preparation for the first use of advertising-enabled wireless terminal 400, as for any GSM-compliant wireless terminal or other wireless terminal that incorporates a SIM. This operation can be performed either by the consumer or the wireless service provider. In embodiments in which the advertising-enabled wireless terminal does not include a SIM, operation 1000 is, of course, not performed. For a new terminal, the battery is inserted after the SIM card.

In operation 1004, a consumer inserts sponsor card 300, which, in the illustrative embodiment, is a sponsored phone card. Advertising-enabled wireless terminal 400 senses the presence of sponsor card 300 in sponsor-card receiver 424, and the terminal activates.

The operations that follow are for initializing wireless terminal 400. If the terminal has already been initialized and the information module has wireless minutes still available, then these operations are not performed.

In operation 1006, process and control circuitry 402 within advertising-enabled wireless terminal 400 issues a pin or code for the SIM card. This pin remains unknown to the user of terminal 400. In subsequent uses of the terminal, after inserting sponsor card 300, the SIM will query terminal 400 for this pin. The terminal provides the pin, thereby unlocking the SIM card for use. This first authentication operation is invisible to the user.

If the user attempts to transfer a charged SIM card to a conventional wireless terminal, the SIM will again query the terminal for the pin. Since the terminal will be incapable of providing the pin, the user will be queried. Since the user doesn't know the pin, the SIM cannot be unlocked without intervention by the manufacturer of advertising-enabled wireless terminal.

In operation 1008, sponsor-card reader 426 extracts the code embodied in mechanical key 304 on sponsor card 300. The code is saved in a buffer accessible to processor and control circuitry 402. Operations 1006 and 1008 can be performed in reverse order.

In operation 1010, information string 310 is input, via key pad 416, into advertising-enabled wireless terminal 400. If the terminal includes appropriate voice-recognition capabilities, then information string 310 can be input to the wireless terminal by verbally reciting the string.

In the illustrative embodiment, after information string 310 is entered, it is transmitted to a buffer that is accessible to processor and control circuitry 402. In operation 1012, first sub-string 802 and second sub-string 804 are extracted from information string 310 via appropriate decryption.

In a second authentication process that is conducted in operation 1014, the code extracted from mechanical key 304 is compared to first'sub-string 802. If the “candidate” authentication code extracted from mechanical key 304 matches the “valid” authentication code from first sub-string 802, the sponsor card is validated.

The second authentication operation is important to the sponsor. This prevents a user from inputting information string 310 from a first sponsor card but inserting a second sponsor card in sponsor card receiver 424. The following example will illustrate the problem.

A user might be enticed to purchase a sponsor card from a first sponsor because the card offers very cheap wireless minutes due, for example, to a large subsidy paid by that sponsor. But the image on the sponsor card might be undesirable to the purchaser for any number of reasons. Assume that the purchaser had previously purchased and used another sponsor card. Further assume that the old sponsor card has an advertising graphic that the user prefers over the graphic that appears on the new sponsor card.

If the capability of sponsor card reader 426 were limited to simply detecting the presence of a sponsor card, there would be no way to prevent a user from inserting the old sponsor card rather than the new card. If that were the case, the first sponsor does not receive full value for the substantial compensation that it paid to the wireless service provider or other entity for the advertising.

If the sponsor card is authenticated, advertising-enabled wireless terminal 400 permits the user to place a call to the wireless network to charge the SIM card. Operation 1016 recites placing a call to the wireless network to charge the SIM card.

The call is placed and, in accordance with operation 1018, second sub-string 804, which embodies the “network pin,” is sent to the wireless service provider. In operation 1020, this “candidate” code is compared against codes maintained by the wireless service provider. If there is a match, an authorization is returned to the SIM card within advertising-enabled wireless terminal 400 for the amount of the wireless service purchased, as per operation 1022. The advertising-enabled wireless terminal is now ready to use the service purchased via sponsor card 300.

After initialization, and assuming that the sponsor card remains in the advertising-enabled wireless terminal, whenever the terminal is turned on, the SIM card will query the terminal for the SIM-lock pin. The terminal provides it, and then the terminal is ready for use. The network keeps track of the “minutes” remaining on the SIM. At some point, typically before the available time is used, the user must purchase a new sponsor card and re-charge the SIM card (i.e., obtain authorization for an additional amount of wireless service).

Typically, a user will purchase additional wireless service before using all of the service that was previously purchased. As a consequence, the user will be removing the sponsor card “prematurely,” and replacing it with a different card (and using the new card to purchase additional service). For example, consider a situation in which a user purchases a $50 sponsor card, which is sponsored by Coca Cola®, for $48 dollars. After using only $10 worth of service, the user sees that Pepsi Cola® is sponsoring a $50 card, and it will only cost $45 dollars. To take advantage of these heavily subsidized wireless minutes, the user purchases the card and charges his SIM with an additional $50 dollars worth of wireless service. Now, $50−$10+$50=$90 worth of service have been purchased by the user. The user can keep the Pepsi Cola® card in the terminal until the $90 of service is used. In such a case, Coca Cola® has not received full benefit for its advertising, while Pepsi Cola® has received more than it paid for.

It is expected that, to the extent that this occurs, it should balance out over time. And, simply put, this is the nature of competition. The sponsor that provides the greater subsidy can be expected to spend more time in advertising-enabled wireless terminal 400.

It is understood that the various embodiments shown in the FIGS. are illustrative, and are not necessarily drawn to scale. Reference throughout the specification to “one embodiment” or “an embodiment” or “some embodiments” means that a particular feature, structure, material, or characteristic described in connection with the embodiment(s) is included in at least one embodiment of the present invention, but not necessarily all embodiments. Furthermore, it is to be understood that the above-described embodiments are merely illustrative of the present invention and that many variations of the above-described embodiments can be devised by those skilled in the art without departing from the scope of the invention. It is therefore intended that such variations be included within the scope of the following claims and their equivalents.

What is claimed:

1. A method for using a wireless terminal comprising unlocking an information module within said wireless terminal when a second code matches a first code, wherein:
(iv) said wireless terminal generates said first code;
(v) said first code is unknown to a user;
(vi) said wireless terminal provides said second code.

2. The method of claim 1 further comprising locking said information module when said wireless terminal is turned off.

3. The method of claim 1 further comprising issuing a query for said second code after turning on said wireless terminal.

4. The method of claim 3 wherein, in response to said query for said second code, said wireless terminal generates said second code.

5. The method of claim 3 wherein, in response to said query for said second code, said wireless terminal retrieves said second code from memory.

6. The method of claim 1 further comprising:
receiving a card in said wireless terminal;
obtaining a first code from said card, wherein said first code is embodied in a physical key of said card; and
comparing said first code to a second code associated with said card, wherein said second code is embodied in an information string.

7. The method of claim 6 wherein the operation of obtaining said first code further comprises reading it using a sensing device.

8. The method of claim 6 wherein the operation of obtaining said first code further comprises physically coupling said physical key to electromechanical contacts of said wireless terminal.

9. The method of claim 6 wherein said physical key is selected from the group consisting of a plurality of fingers that depend from an end of said card, a plurality of holes that are disposed in a region of said card, and a plurality of contacts that are disposed near an end of said card.

10. The method of claim 6 wherein said first code is encrypted.

11. The method of claim 6 further comprises receiving said second code from an input device of said wireless terminal.

12. The method of claim 11 wherein said a candidate authentication code and said valid authentication code are embodied as a different form from one another.

13. The method of claim 6 wherein said second code is encrypted in said information string.

14. The method of claim 1 wherein said information module is a subscriber identity module.

15. A method for using a wireless terminal, the method comprising:
(i) receiving a first code at said wireless terminal, wherein said first code is encrypted in an information string that is associated with a phone card;
(ii) receiving said phone card in said wireless terminal;
(iii) reading a second code from said phone card, wherein said second code is embodied in a mechanical key of said card, and wherein said wireless terminal reads said second code; and
(iv) comparing said first code and said second code.

16. The method of claim 15 wherein said first code is indicative of a sponsor of said phone card.

17. The method of claim 15 further comprising:
(v) transmitting a third code to a service provider network when said first code and said second code are identical.

18. The method of claim 17 further comprising:
(vi) receiving authorization for an amount of wireless service when said third code is determined by said service provider network to be valid.

19. A method for using a wireless terminal, the method comprising unlocking an information module within said wireless terminal, wherein said information module is unlocked via a code that remains unknown to a user.

20. The method of claim 19 further comprising:
receiving a card in said wireless terminal; and
reading a code from said card, wherein said code is read by said wireless terminal.
